(19) United States
(12) Patent Application Publication
(10) Pub. No.: US 2026/0012771 A1
(43) Pub. Date: Jan. 8, 2026

(54) Emergency Broadcast System with Capability to Interrupt Immersive Entertainment Sources

(71) Applicant: Charter Communications Operating, LLC, St. Louis, MO (US)

(72) Inventors: Ian D. BIGGS, Parker, CO (US); David T. MORAN, Centennial, CO (US); Ryan P. SPITTLER, Highlands Ranch, CO (US)

(21) Appl. No.: 18/762,568

(22) Filed: Jul. 2, 2024

(51) Int. Cl. H04W 4/90; H04W 4/021

(52) U.S. Cl. CPC H04W 4/90; H04W 4/021

(57) ABSTRACT

Systems, methods, and devices for delivering emergency alerts to users engaged in immersive entertainment experiences. The methods may include subscribing to established emergency broadcast systems, detecting new alerts, generating alert events, identifying and classifying client devices, and delivering alerts by interrupting immersive activities to display emergency alerts within immersive environments for the timely delivery of critical information.

### BACKGROUND

Immersive entertainment technologies, such as virtual reality (VR) and augmented reality (AR), have become increasingly popular, providing users with highly engaging and interactive experiences. These technologies immerse users in virtual environments, often causing them to become deeply absorbed and less aware of their real-world surroundings. This heightened level of engagement presents a challenge for traditional emergency broadcast systems, which rely on technologies such as linear cable, over-the-air television, and cellular broadcasts to deliver important alerts. The effectiveness of these traditional emergency broadcast systems diminishes as users spend more time in immersive environments.

Existing emergency broadcast systems may provide timely alerts about severe weather conditions, natural disasters, public safety threats, and other important events. Traditional methods, while effective in reaching a broad audience, may not penetrate the immersive experiences provided by modern entertainment technologies. Users engaged in VR or AR may not hear or see conventional alerts, necessitating the development of a system capable of interrupting these immersive activities to deliver emergency notifications. The intelligent integration of emergency alert systems with immersive entertainment devices could allow users to receive important information and/or otherwise enhance overall safety and responsiveness during emergencies.

### SUMMARY

Various aspects include methods of delivering emergency alerts to users engaged in immersive entertainment experiences, the method which may include subscribing, by a processing system in a service provider network, to established emergency broadcast systems to receive real-time alerts from sources, detecting, by the processing system, a new emergency alert from the subscribed emergency broadcast systems, generating, by the processing system, an alert event based on the detected emergency alert for gateway devices within an affected area, identifying, by the processing system, client devices connected to the network and classifying them as immersive or non-immersive based on at least one of hardware identification, analysis of protocol, and analysis of traffic patterns, and causing, by the processing system, the identified immersive client devices to interrupt ongoing immersive activities and display the emergency alert within an immersive environment of the identified immersive client devices by sending the generated alert event from the processing system to the identified immersive client devices.

In some aspects, the source is a reliable authoritative source that provides accurate real-time alerts. In some aspects, generating the alert event based on the detected emergency alert for gateway devices within the affected area may include localizing the alert event based on the geographic area specified in the detected emergency alert, and tailoring the alert message to the specific type and severity of the emergency.

In some aspects, causing the identified immersive client devices to interrupt the ongoing immersive activities and display the emergency alert within the immersive environment of the identified immersive client devices by sending the generated alert event from the processing system to the identified immersive client devices may further include generating an audible warning sound or a flashing visual signal, or displaying alert details on an LCD display in response to determining that the immersive client devices do not support in-environment alert messages. Some aspects may further include determining, by the processing system, whether a primary alert delivery method has failed, and disconnecting, by the processing system, the immersive client devices from the network and causing other Internet of Things (IoT) devices on the same local network to emit alerts via sounds or visual signals in response to determining that the primary alert delivery method failed.

Some aspects may further include using an alternative communication method to propagate emergency alerts in response to determining that the main communication infrastructure may be compromised, the alternative communication method which may include at least one of a Bluetooth communication method or peer-to-peer network communication method. Some aspects may further include identifying and analyzing network traffic to identify immersive client devices, interrupting network connections of the identified immersive client devices, and sending prompts regarding emergency alerts to the identified immersive client devices with interrupted network connections.

Further aspects may include a computing device having a processor or processing system configured with processor-executable instructions to perform various operations corresponding to the methods discussed above. Further aspects may include a computing device having various means for performing functions corresponding to the method operations discussed above. Further aspects may include a non-transitory processor-readable storage medium having stored thereon processor-executable instructions configured to cause a processor or processing system to perform various operations corresponding to the method operations discussed above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of various embodiments.

FIG. 1 is a block diagram of an example network that is suitable for implementing some embodiments.

FIGS. 2 and 3 are process flow diagrams illustrating methods of delivering emergency alerts to users engaged in immersive entertainment experiences in accordance with some embodiments.

FIG. 4 is a component diagram of an example server suitable for implementing the various embodiments.

### DETAILED DESCRIPTION

The various embodiments will be described in detail with reference to the accompanying drawings. The same reference numbers will be used throughout the drawings to refer to the same or like parts wherever possible. References to particular examples and implementations are for illustrative purposes and are not intended to limit the scope of the invention or the claims.

In overview, the various embodiments include methods, and computing systems configured to implement the methods, of delivering emergency alerts to users engaged in immersive entertainment experiences. The methods may include subscribing to an established emergency broadcast system to receive real-time alerts from sources, detecting new alerts from these systems, generating an alert event based on the detected alert for gateway devices within an affected area, identifying client devices connected to the network, classifying them as immersive or non-immersive based on at least one of hardware identification, analysis of protocol, and analysis of traffic patterns, sending the generated alert event to the identified immersive client devices, and interrupting ongoing immersive activities to display the emergency alert within the immersive environment.

Various embodiments disclosed herein may improve the performance and functioning of the communication network and its constituent components (e.g., user devices, etc.) by improving the detection and classification of immersive client devices and applications. Various embodiments disclosed herein may reduce unnecessary network traffic and processing overheads (e.g., by targeting only the devices engaged in immersive activities, etc.), enhance the relevance and effectiveness of alerts (e.g., by localizing and tailoring messages based on geographic areas and the severity of the emergency, etc.), seamlessly integrate with existing emergency broadcast systems, and use alternative communication methods, such as Bluetooth and peer-to-peer networks, to ensure robust alert delivery even in instances in which the primary communication infrastructure is compromised. Some embodiments may provide a flexible and user-centric approach to managing alert subscriptions (e.g., by offering options for automated or manual device registrations), facilitate seamless integration with various different types of devices and platforms (e.g., by providing a framework and library for local area network client systems, etc.), and otherwise enhance the reliability and user experience of the emergency alert system (e.g., by performing periodic system tests, collecting and analyzing user feedback, etc.). These improvements in performance, functionality, user awareness, and user engagement may contribute to a more effective and efficient communication network that improves public safety and awareness. Additional improvements to the performance and functionality of the communication network and its constituent components will be evident from the disclosures below.

The term “service provider network” may be used generically herein to refer to any network suitable for providing consumers with access to the Internet or IP services over broadband connections, encompassing both wired and wireless networks and technologies. Wired network technologies may include active Ethernet networks, asymmetric digital subscriber line (ADSL) technologies, cable networks, data over cable service interface specification (DOCSIS) networks, enhanced ADSL (ADSL2+), Ethernet, fiber optic networks, fiber-to-the-x (FTTx) technologies, hybrid-fiber-cable (HFC) networks, local area networks (LAN), metropolitan area networks (MAN), passive optical networks (PON), satellite networks, wide area networks (WAN), 10 Gigabit Symmetrical Passive Optical Network (XGS-PON), among others. Wireless network technologies may include third-generation wireless mobile communication technology (3G), third generation partnership project (3GPP), 3GSM, fourth-generation wireless mobile communication technology (4G), fifth-generation wireless mobile communication technology (5G), sixth-generation wireless (6G), advanced mobile phone system (AMPS), Bluetooth®, Code Division Multiple Access (CDMA) systems (e.g., cdmaOne, CDMA2000), Digital Enhanced Cordless Telecommunications (DECT), digital AMPS (IS-136/TDMA), Enhanced Data rates for GSM Evolution (EDGE), Evolution-Data Optimized (EV-DO), General Packet Radio Service (GPRS), Global System for Mobile Communications (GSM), High-Speed Downlink Packet Access (HSDPA), Integrated Digital Enhanced Network (iDEN), land mobile radio (LMR), Long Term Evolution (LTE) systems, low earth orbit (LEO) satellite internet technologies, massive multiple input multiple output (MIMO), millimeter-wave (mmWave) technologies for higher-speed wireless communication, New Radio (NR), next-generation wireless systems (NGWS), Universal Mobile Telecommunications System (UMTS), Wi-Fi 7 (802.11be), Wi-Fi Protected Access I & II (WPA, WPA2), wireless local area network (WLAN), Worldwide Interoperability for Microwave Access (WiMAX), and others. Each of these technologies supports the transmission and reception of data, as well as the exchange of signaling and content messages. It should be understood that, while specific technologies and standards are described herein to exemplify the range of capabilities associated with a service provider network, these references and details are included to serve merely as illustrative examples. These references should not be construed as narrowing the scope of the claims to any particular communication system or technology unless specifically recited in the claim language.

The terms “computing device,” “user device,” and “user equipment” (UE) may be used interchangeably herein to refer to any of a wide variety of electronic devices capable of executing programmed instructions. These devices include smartphones, advanced cellular telephones, smart televisions, interactive voice-controlled assistants, contemporary digital video recorders (DVRs), smartwatches, residential and bridged gateways, laptops, tablets, satellite or cable set-top boxes (STBs), portable multimedia players, network-connected storage and gaming solutions, wearable fitness trackers, home automation interfaces, virtual reality (VR) headsets, augmented reality (AR) glasses, and other similar devices equipped with processors, memory, and/or integrated circuitry to facilitate the functionalities described herein. Modern computing devices typically support connectivity to various networks through modems, routers, and network switches, including advancements such as 5G-enabled smartphones and tablets, home IoT (Internet of Things) hubs, and ultra-high-definition streaming media devices. These devices may function as immersive client devices within the context of the emergency alert system, receiving and displaying alerts during immersive activities to ensure user safety and awareness.

The terms “component,” “module,” “system,” “engine,” and the like are used in this application to refer to various computer-related entities tasked with specific operational functions. These may include hardware components, software programs, combinations thereof, or processes in execution. For example, a component may be a software application executing on a device, a processor executing instructions, a thread of a program, or the device itself. Components may operate individually within a single processing environment or may be distributed across multiple processing units to use the capabilities of multicore or parallel computing architectures. Components may execute instructions stored on different types of non-transitory computer-readable media and communicate via local or remote process interactions, inter-process communications, electronic signaling, data packet transfers, and other established protocols for data exchange and function coordination.

The term “processing system” may be used herein to refer to one or more processors, including multi-core processors, that are organized and configured to perform various computing functions. Various embodiment methods may be implemented in one or more of multiple processors within a processing system, as described herein.

The term “system on chip” (SoC) may be used herein to refer to a single integrated circuit (IC) chip that contains multiple resources or independent processors integrated on a single substrate. A single SoC may contain circuitry for digital, analog, mixed-signal, and radio-frequency functions. A single SoC may include a processing system that includes any number of general-purpose or specialized processors (e.g., network processors, digital signal processors, modem processors, video processors, etc.), memory blocks (e.g., ROM, RAM, Flash, etc.), and resources (e.g., timers, voltage regulators, oscillators, etc.). For example, an SoC may include an applications processor that operates as the SoC's main processor, central processing unit (CPU), microprocessor unit (MPU), arithmetic logic unit (ALU), etc. An SoC processing system may also include software for controlling integrated resources and processors, as well as for controlling peripheral devices. As an example, a SoC may be used within immersive client devices (e.g., VR headsets, AR glasses, etc.) to manage and display emergency alerts effectively.

The term “system in a package” (SIP) may be used herein to refer to a single module or package that contains multiple resources, computational units, cores, or processors on two or more IC chips, substrates, or SoCs. For example, a SIP may include a single substrate on which multiple IC chips or semiconductor dies are stacked vertically. Similarly, the SIP may include one or more multi-chip modules (MCMs) on which multiple ICs or semiconductor dies are packaged into a unifying substrate. A SIP may also include multiple independent SOCs coupled together via high-speed communication circuitry and packaged in close proximity, such as on a single motherboard, in a single UE, or in a single CPU device. The proximity of the SoCs facilitates high-speed communications and the sharing of memory and resources. As an example, a SIP may be used in network gateway devices to efficiently process and disseminate emergency alerts to connected immersive client devices.

The term “immersive client device” may be used herein to refer to any user device that provides an immersive entertainment experience, including UE devices such as smartphones, virtual reality (VR) headsets, augmented reality (AR) glasses, or other similar devices. These devices are typically equipped with processors and integrated circuitry to facilitate immersive activities. In some embodiments, these devices may be identified by the emergency alert management processor (EAMP) based on hardware characteristics and network traffic patterns (e.g., for the purpose of delivering emergency alerts, etc.).

The term “alert” may be used herein to refer to any communication message, information structure, or information unit that conveys important information regarding an emergency situation. Alerts may include details such as the type of emergency, its severity, the geographic area affected, and instructions for protective actions. The alerts may be transmitted to immersive client devices to ensure users receive timely and pertinent information (even while engaging in activities in immersive environments). The processing system may process these alerts to ensure they are formatted and delivered in a manner suitable for display within virtual or augmented reality experiences.

The term “emergency alert management processor” (EAMP) may be used herein to refer to a specialized processing system integrated within the service provider's network infrastructure. The EAMP may be responsible for subscribing to established emergency broadcast systems, detecting new alerts, generating alert events, identifying and classifying client devices, and managing the delivery of alerts to immersive client devices. The EAMP may perform various functions to improve the delivery of emergency alerts, such as initializing the emergency alert subsystem, setting up the event publication framework, and monitoring the emergency alert database for new alerts.

The term “gateway device” may be used herein to refer to network access points that facilitate the connection of user devices to the service provider network. Gateway devices may include routers, modems, or other network infrastructure components that receive alert events from the EAMP and deliver these alerts to connected immersive client devices. Gateway devices may also be equipped with additional functionalities, such as emitting audible warning sounds, flashing visual signals, or displaying alert details on LCD screens, to ensure that users receive emergency notifications even if their immersive client devices do not support in-environment messages.

The term “alternative communication method” may be used herein to refer to supplementary communication technologies used to propagate emergency alerts when the primary communication infrastructure is compromised. Alternative communication methods may include Bluetooth communication, peer-to-peer network communication, or other short-range communication protocols. These methods may help ensure the continued delivery of emergency alerts to immersive client devices even in scenarios in which conventional network connectivity is disrupted.

The term “network traffic patterns” may be used herein to refer to the characteristics and behaviors of data transmitted and received over a network. Analysis of network traffic patterns may include examining data packet sizes, protocols used, bandwidth consumption, and frequency of data exchanges. This analysis may help identify and classify devices connected to the network, particularly in distinguishing immersive client devices from non-immersive devices based on their usage profiles and data transmission characteristics.

Some embodiments may include an emergency alert management processor (EAMP) integrated into the service provider's network infrastructure. The EAMP may be configured to receive real-time alerts from established emergency broadcast systems, such as the National Oceanic and Atmospheric Administration (NOAA) and other governmental and non-governmental alert systems. The EAMP may initialize the emergency alert subsystem, set up the event publication framework, identify and classify devices connected to the network, and manage the delivery of alert events to immersive client devices. In addition, the EAMP may monitor the emergency alert database, retrieve alert details, generate alert events for gateway devices within affected areas, and cause the timely and effective interruption of immersive activities for displaying important emergency alerts.

The EAMP may perform various functions to improve the delivery of emergency alerts to immersive client devices. For example, the EAMP may initialize the emergency alert subsystem to establish a foundation for real-time alert processing, connect to established emergency broadcast systems to ensure receipt of authoritative alerts, and set up the event publication framework to facilitate the dissemination of alert events within the network. The EAMP may identify and classify devices connected to the network as immersive or non-immersive based on hardware identification and analysis of protocol and traffic patterns. This classification may allow for targeting the appropriate devices. The EAMP may also allow users to manually register and classify devices, providing flexibility and control over alert subscriptions. It may subscribe to events from emergency broadcast systems and continuously update the emergency alert database with new alert events in real time. Upon detecting a new alert, the EAMP may retrieve alert details, including type, severity, and geographic area.

The EAMP may identify client devices within the affected area, generate an alert event for each identified immersive client device, and determine the appropriate alert delivery method, such as in-immersive experience messages, audible warnings, or visual signals. The EAMP may send the alert event to the immersive client, which may display the alert message within the immersive environment. In instances in which immersive clients do not support in-environment messages, the EAMP may send a disconnection signal and may also emit an audible warning sound and/or a flashing visual signal on the user device (or gateway device), as well as scroll alert details on the device's LCD display. In instances in which the primary alert delivery method fails, the EAMP may disconnect the immersive client from the network and ensure that other devices (e.g., Internet of Things (IoT) devices, etc.) on the same network emit alerts through sounds or visual means. The EAMP may provide users with options to opt-in or opt-out of receiving alerts, collect feedback from users regarding the alert delivery mechanism, and adjust system settings based on this feedback to improve effectiveness and user experience.

The EAMP may regularly update the emergency alert subsystem to accommodate new types of alerts and improve overall performance. The EAMP may collaborate with device manufacturers to ensure compatibility with new immersive client devices and technologies and conduct periodic system tests to ensure the reliability and accuracy of alert delivery. The EAMP may determine the geographic area affected by the alert, identify and target specific zip codes or addresses within the area, and differentiate alerts based on severity and type. The EAMP may tailor (i.e., customize) alert messages to the specific event and user preferences. The EAMP may use Bluetooth and peer-to-peer communication to propagate alerts in case of a failure in the main communication infrastructure. The EAMP may allow devices within a local network to share emergency messages using short-range communication technologies.

The EAMP may work with device manufacturers to implement client-side functionality for handling and displaying alerts and develop a standard for self-identifying immersive client devices to facilitate seamless integration with the emergency alert system. The EAMP may configure routers to recognize and manage network traffic for emergency alerts so that the routers may send prompts to connected devices and interrupt network connections when necessary. For example, the EAMP may interrupt VR headset users with urgent weather warnings displayed directly within their field of view, use smart home devices to flash or produce sounds alerting users of an emergency, and send targeted alerts to specific neighborhoods during critical events (e.g., the Boston Marathon bombing, etc.) without tipping off nefarious actors. For these and other reasons, the EAMP may provide a comprehensive and reliable emergency alert system (e.g., for users engaged in immersive entertainment experiences, etc.) that enhances public safety and responsiveness during important events.

Thus, the EAMP may implement a warning system that is configured to overcome the limitations of related instances of emergency broadcast systems in reaching users engaged in highly immersive virtual reality (VR) and augmented reality (AR) environments by interrupting immersive entertainment to alert users of imminent danger or emergency broadcasts from sources (i.e., authoritative sources). The service provider subscribes to events from established emergency broadcast systems to receive real-time alerts from authoritative sources. Emergency broadcast systems register and publish events to the emergency alert subsystem, which may be an in-house solution or a third-party middleware designed to interface with multiple service providers and emergency broadcast systems. Devices connected to the network may be identified as immersive entertainment devices through hardware identification and analysis of protocol and traffic patterns. Manual classification and subscription to alerts may also be supported options. Users may have the flexibility to manually classify and subscribe to client devices to receive alerts. A library or framework may be provided for local area network (LAN) client systems to utilize, enabling them to react to event-based alerts from the provider side.

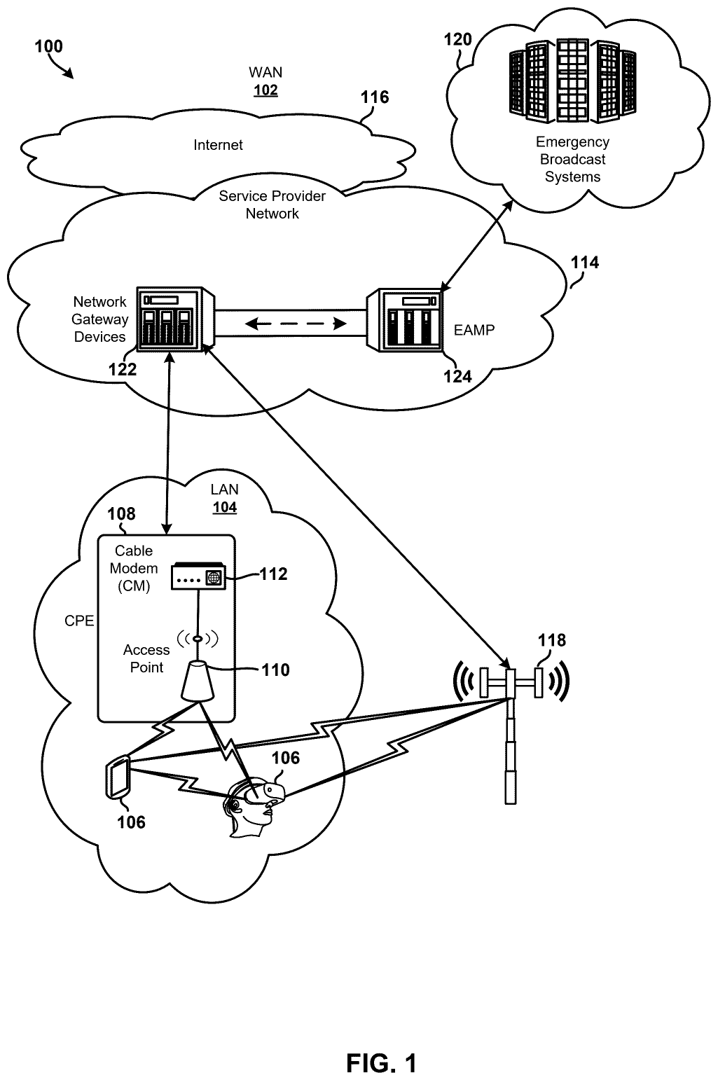

FIG. 1 illustrates a simplified example of a network 100 suitable for implementing various embodiments. The network configuration includes a wide area network (WAN) 102 and a local area network (LAN) 104. Within the LAN 104, user equipment (UE) 106 devices connect to customer premises equipment (CPE) 108 via wired and wireless communication links.

The CPE 108 may include a wireless access point (AP) 110 and a cable modem (CM) 112 that together provide network connectivity to a home or small office network. In various embodiments, the CPE 108 may also include components such as a digital subscriber line (DSL) modem, router, switch, firewall, packet filter, or residential gateway. These components allow UE 106 devices on the LAN 104 to connect to the service provider network 114 and, ultimately, the Internet 116.

The cable modem (CM) 112 may function as a network bridge, enabling bidirectional data communications over radio frequency channels within a hybrid fiber-coaxial (HFC) and/or radio frequency over glass (RFOG) infrastructure. A cable modem termination system (CMTS), typically located within a headend or hubsite, may facilitate high-speed communications between the CM 112 and other components of the service provider network 114, providing consumer access to the Internet 116 and IP services over broadband connections.

The network 100 may also include base stations 118 and other core network or cellular/wireless network components. A network controller may couple to a set of base stations 118 and provide coordination and control for these base stations. The network controller may communicate with the base station 118 via a backhaul. The base station 118 may also directly or indirectly communicate with one another via a wireless or wireline backhaul. The base station 118 may also be referred to as a Node B, an LTE Evolved NodeB (eNodeB or eNB), an access point (AP), a radio head, a transmit-receive point (TRP), a New Radio base station (NR BS), a 5G NodeB (NB), a Next Generation NodeB (gNodeB or gNB), or the like. Each base station 118 may provide communication coverage for a macro cell, a pico cell, a femto cell, another type of cell, or a combination thereof. Some embodiments may include two or more base stations 118 interconnected to one another and to one or more other base stations or network nodes (not illustrated) in the communications system through various types of backhaul interfaces, such as a direct physical connection, a virtual network, or a combination thereof using any suitable transport network.

The core network may be any type, such as an LTE core network (e.g., Evolved Packet Core (EPC)) or a 5G core network. The base station 118 may connect to the core network using wireless or wired links. Wired links may include Ethernet, TV cable, telephony, fiber optic, and other physical connections using protocols like Ethernet, Point-To-Point, High-Level Data Link Control (HDLC), Advanced Data Communication Control Protocol (ADCCP), and Transmission Control Protocol/Internet Protocol (TCP/IP). Wireless links may use various carrier signals, frequencies, or bands with multiple logical channels, employing radio access technologies (RATs) like 3GPP LTE, 5G, GSM, CDMA, WCDMA, WiMAX, Time Division Multiple Access (TDMA), and other mobile telephony technologies. Additional RATs may include medium-range protocols like Wi-Fi, LTE-U, LTE-Direct, LAA, MuLTEfire, and short-range RATs like ZigBee, Bluetooth, and Bluetooth Low Energy (LE). In addition, wired communication links may be established between devices in the communications system via physical wired connections, such as universal serial bus (USB) connections, peripheral component interconnect express (PCIe) connections, high-speed inter-chip (HSIC) connections, and Ethernet connections.

The service provider network 114 may connect to an emergency broadcast system (EBS) 120 located in the WAN 102. The EBS 120 may send emergency alerts through the service provider network 114 to the CPE 108, which may send these alerts to the UE 106 devices via the AP 110. The EBS 120 may be configured so that users receive critical information promptly and efficiently regardless of the current network connections. In some embodiments, the EBS 120 may be configured to send emergency alerts from any of a variety of governmental and non-governmental alert systems, including but not limited to the National Oceanic and Atmospheric Administration (NOAA), the Federal Emergency Management Agency (FEMA), local and state emergency management agencies, the National Weather Service (NWS), the Amber Alert system, and various international alerting systems.

The service provider network 114 may also include a network gateway device 122 and an emergency alert management processor (EAMP) 124. In some embodiments, the EAMP 124 may be included as part of the network gateway device 122.

The network gateway device 122 may connect UE 106 devices to the service provider network 114 and facilitate the transmission of data and alerts. The network gateway device 122 may include routers, modems, or other network access points that may receive alert events from the EAMP 124 and deliver these alerts to the connected immersive client devices (e.g., UE 106, etc.), either by direct in-immersive experience messages or through audible and visual signals.

The EAMP 124 may be a component, processor, or device that is deployed within a service provider network 114 and configured to manage and process emergency alerts. The EAMP 124 may be configured to initialize the emergency alert subsystem(s), connect to established emergency broadcast systems 120, and set up the event publication framework. The EAMP 124 may identify devices connected to the network, classify them as immersive or non-immersive based on hardware identification and traffic pattern analysis, and allow manual device registration and classification by users. The EAMP 124 may subscribe to events from emergency broadcast systems 120, update an emergency alert database with new alert events in real time, and monitor this database continuously for new alerts. Upon detecting a new alert, the EAMP 124 may retrieve the alert details (e.g., type, severity, geographic area, etc.), identify client devices within the affected area, generate an alert event for each identified immersive client device, and determine the appropriate alert delivery method (e.g., in-immersive experience messages, audible warnings, visual signals, etc.). The EAMP 124 may send the alert event to the immersive client, display the alert message within the immersive environment, and, if necessary, emit an audible warning sound and/or flashing visual signal on a gateway device (or scroll alert details on the gateway device's LCD display, etc.). In instances in which the primary alert delivery method fails, the EAMP 124 may disconnect the immersive client from the network and ensure other IoT devices on the same network emit alerts through sounds or visual means.

In some embodiments, the quantity and quality of the audible, visual, and haptic signals may be initiated depending on the type and/or severity of the emergency situation. For example, in the instance of an “amber alert” where citizens are asked to be observant of certain individuals or situations, the user may be alerted by providing a flashing light and/or chyron across the user's display. However, in the instance of an impending tornado touch down in the immediate geographic area, the system may not only provide a flashing light and audible signal but any IoT device connected to the LAN 104 may be activated to attract the attention of the user/occupant of the LAN location. In this manner, the user may be alerted to the sever emergency situation.

In some embodiments, the service provider network 114 may include various additional emergency alert subsystem components that are responsible for receiving, processing, and disseminating emergency alerts to client devices. This subsystem may interface with established emergency broadcast systems 120, update the emergency alert database in real-time, and coordinate with the EAMP 124 to deliver alerts to the appropriate devices (e.g., UE 106) based on their classification and network status.

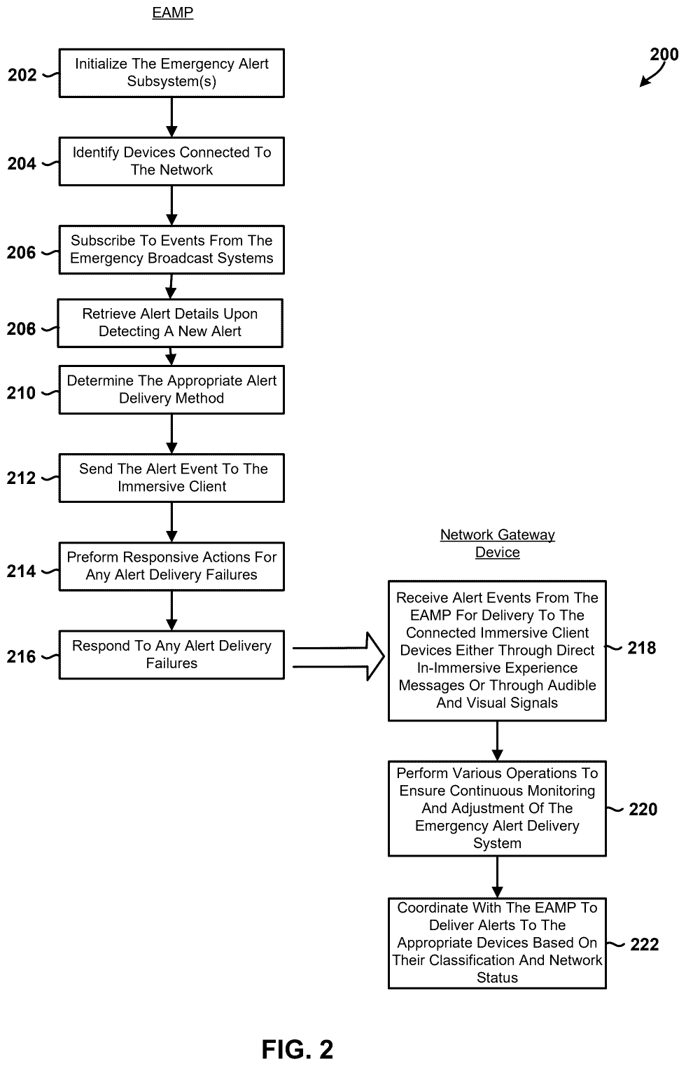

FIG. 2 is a process flow diagram illustrating method 200 of delivering emergency alerts to users engaged in immersive entertainment experiences in accordance with some embodiments. With reference to FIGS. 1 and 2, method 200 may be performed in a computing device by a processing system encompassing one or more components or subsystems discussed in this application (e.g., the EAMP 124, network gateway device 122, etc.). Means for performing the functions of the operations in method 200 may include a processing system including one or more processors and other components described herein. Further, one or more processors of a processing system may be configured with software or firmware to perform some or all of the operations of method 200. To encompass the alternative configurations enabled in various embodiments, the hardware implementing any or all of the method 200 is referred to herein as a “processing system.”

In block 202, a processing system in the emergency alert management processor (EAMP) (or in another network component) may initialize the emergency alert subsystem(s). In some embodiments, the processing system in EAMP may be included in a network gateway device (e.g., network gateway device 122, etc.). The initialization operations may include setting up connections with established emergency broadcast systems (e.g., EBS 120), preparing the event publication framework for receiving and processing emergency alerts, and performing other similar operations to help ensure that real-time alerts from authoritative sources are integrated into the system.

In block 204, the processing system in the EAMP may identify devices connected to the network, which may include classifying the devices as immersive or non-immersive based on hardware identification and traffic pattern analysis. For example, the processing system may query network components (e.g., routers, switches, etc.) to obtain a list of active devices and collect information (e.g., MAC addresses, IP addresses, device names, etc.) from the active devices. In some embodiments, the processing system may use the collected MAC addresses to identify the hardware characteristics of each device by referencing vendor-specific databases or using manufacturer APIs. For example, a MAC address starting with “00:1A:79” may indicate an OCULUS VR headset, while a device named “Quest2” may be identified as an OCULUS Quest 2.

In some embodiments, the processing system may analyze the traffic patterns of each device to determine its usage profile. For example, the processing system may analyze data packet sizes, protocols used, and bandwidth consumption. As a further example, the processing system may determine that the network traffic indicates immersive content usage in response to detecting high data consumption with frequent large data packets, continuous low-latency data exchange, significant 3D graphics data transfer, etc.

In some embodiments, the processing system may inspect applications running on each device for specific application signatures or behaviors associated with immersive experiences. For example, applications named “OApp” or “SteamVR” suggest VR usage, while apps accessing AR SDKs (e.g., ARCore, ARKit, etc.) may indicate augmented reality activities. In some embodiments, the processing system may confirm immersive classification by identifying applications that use high graphical data transfer, positional data, or haptic feedback.

In some embodiments, the processing system may also allow users to manually register and classify devices for accurate identification of devices used for immersive experiences.

In block 206, the processing system in the EAMP may subscribe to events from the emergency broadcast systems. This subscription may include updating an emergency alert database with new alert events in real time and continuously monitoring this database for new alerts. This may help ensure that the system remains up to date with the latest emergency information.

In block 208, the processing system in the EAMP may retrieve alert details upon detecting a new alert. These details may include the type, severity, and geographic area of the alert. The processing system may identify client devices within the affected area and generate an alert event for each identified immersive client device for a more targeted and relevant alert delivery.

In block 210, the processing system in the EAMP may determine the appropriate alert delivery method. This determination may include choosing between in-immersive experience messages, audible warnings, and visual signals based on the nature and urgency of the alert. This may ensure that the most effective method is used to alert users. In some embodiments, during an initialization procedure, users may select from a menu of options to determine the alerting configuration options. For example, simpler, less intrusive options for alerting a user may be selected for low severity emergencies. These may include approving the display of a pop-up message in immersive reality setting that interrupts the immersive reality or obscures a portion of the display. Further escalating options may include the generation of an audible alarm through headphones or a gateway speaker. Further options may include the flashing lights or color LEDs. Further escalating options may include disconnecting the client device from the network. Still further escalating options may be the incorporation of other devices such as IoT devices connected to the LAN 104 to activate some alarm.

In block 212, the processing system in the EAMP may send the alert event to the immersive client. These operations may include displaying the alert message within the immersive environment such that the alert is immediately noticeable yet not excessively disruptive. If necessary, the system may also emit an audible warning sound and/or flashing visual signal on a gateway device. This interruption aims to ensure users become aware of the emergency even when deeply engaged in immersive content. In some embodiments, immersive clients may subscribe to the emergency alerts system hosted on a gateway device, which may prompt the immersive client to interrupt ongoing activities and display the alert message within the immersive experience. In addition, the gateway may disconnect the immersive client and emit an audible warning sound, a flashing red light, or scroll alert details on an LCD display. The gateway may also disconnect the immersive client, allowing other Internet of Things (IoT) devices on the same local network to emit alerts through sounds or visual means.

In block 214, the processing system in the EAMP may respond to alert delivery failures. For example, the processing system may disconnect the immersive client from the network and allow other IoT devices on the same network to emit alerts through sounds or visual means in response to determining that the primary alert delivery method has failed. This redundancy may help ensure that the alert reaches the user despite any initial delivery issues.

In block 216, the processing system in the EAMP may log operational data regarding the network performance and customer service levels. This logging may include performing regular network system maintenance, such as updating software and firmware, and conducting other cleanup and maintenance operations for the emergency alert subsystem.

In block 218, the processing system in the network gateway device may facilitate the transmission of data and alerts. The network gateway devices may include routers, modems, or other network access points that receive alert events from the EAMP and deliver these alerts to the connected immersive client devices either through direct in-immersive experience messages or through audible and visual signals.

In block 220, the processing system in the network gateway device may perform various operations to ensure continuous monitoring and adjustment of the emergency alert delivery system. These operations may include dynamically adjusting network configurations to improve service delivery and maintain customer satisfaction. Such continuous monitoring may allow the system to adapt to changing conditions and maintain high performance.

In block 222, the processing system in the network gateway device may coordinate with the EAMP to deliver alerts to the appropriate devices based on their classification and network status. These coordination operations may allow alerts to be effectively communicated to users, providing them with timely and critical information during emergencies. This coordination may help ensure that the right users receive the right alerts in a timely manner, enhancing the effectiveness of the emergency alert system.

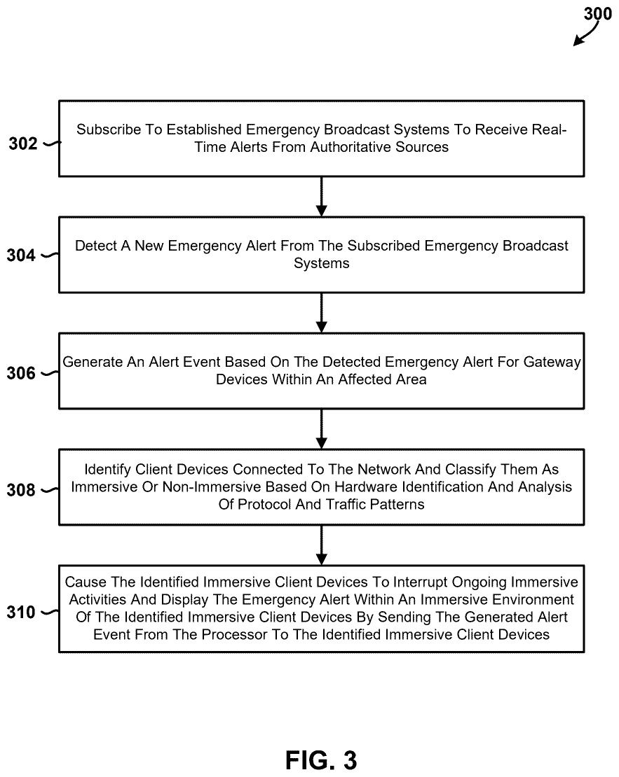

FIG. 3 is a process flow diagram illustrating method 300 of delivering emergency alerts to users engaged in immersive entertainment experiences in accordance with some embodiments. With reference to FIGS. 1-3, method 300 may be performed in a computing device by a processing system encompassing one or more components or subsystems discussed in this application (e.g., the EAMP 124, network gateway device 122, etc.). Means for performing the functions of the operations in method 300 may include a processing system including one or more processors and other components described herein. Further, one or more processors of a processing system may be configured with software or firmware to perform some or all of the operations of method 300. To encompass the alternative configurations enabled in various embodiments, the hardware implementing any or all of the method 300 is referred to herein as a “processing system.”

In block 302, the processing system may subscribe to established emergency broadcast systems to receive real-time alerts from authoritative sources. For example, the processing system may connect to emergency broadcast systems (e.g., NOAA, FEMA) through APIs or other communication protocols and register with these systems to receive continuous updates and alerts. This may allow the processing system to obtain timely and accurate alerts from reliable sources so that it may send users relevant and up-to-date information during emergencies. Each alert may be a communication message or information unit that includes details such as the type of emergency, its severity, and the geographic area affected. The processing system may process these alerts to ensure they are formatted and delivered in a manner suitable for immersive client devices, allowing users engaged in virtual or augmented reality experiences to receive and respond to critical information without significant disruption to their activities.

In block 304, the processing system may detect a new emergency alert from the subscribed emergency broadcast systems. For example, the processing system may continuously monitor the data stream from the subscribed emergency broadcast systems. In some embodiments, the processing system may use event listeners or polling mechanisms to detect new alerts. In response to detecting a new alert, the processing system may parse the alert data to extract relevant details such as type, severity, and affected area.

In block 306, the processing system may generate an alert event based on the detected emergency alert for gateway devices within an affected area. For example, the processing system may use the parsed alert data to generate an alert event that is tailored to the affected geographical area. The generated alert event may include all necessary information, such as the alert type, severity, and instructions for users. In some embodiments, the processing system may also use network topology data to identify network gateway devices within the affected area.

In block 308, the processing system may identify client devices connected to the network and classify them as immersive or non-immersive based on hardware identification and analysis of protocol and traffic patterns. For example, the processing system may query the network to obtain a list of connected devices and analyze hardware identifiers (e.g., MAC addresses) and network traffic patterns to classify devices. For example, devices with high data consumption, frequent large data packets, and specific protocols may be identified as immersive.

In block 310, the processing system may cause the identified immersive client devices to interrupt ongoing immersive activities and display the emergency alert within an immersive environment of the identified immersive client devices by sending the generated alert event from the processor to the identified immersive client devices. That is, in block 310, the processing system may interrupt ongoing immersive activities on identified immersive client devices to display emergency alerts. The processing system may achieve this by sending the alert event to the client devices through the network using APIs or direct communication protocols. This may include overlaying the alert message within the immersive environment to ensure it is prominently visible to the user. In addition, the processing system may trigger an audible alert, such as a warning tone or spoken message, to further capture the user's attention.

The processing system may be configured to use alternative methods in response to determining that the immersive client devices do not support direct in-environment alert messages. These methods may include causing connected gateway devices to emit an audible warning sound or flash visual signals. The processing system may also display alert details on an external LCD display connected to the gateway device, providing multiple channels to ensure the user is aware of the emergency situation. This multi-channel approach may help ensure that users receive timely and critical information regardless of their device's capabilities.

In some embodiments, the processing system may be configured to determine whether a primary alert delivery method has failed and take corrective actions. For example, in instances in which the processing system detects that the primary alert delivery method has failed, the processing system may disconnect the immersive client devices from the network. This disconnection may prompt users to check their network status and notice the emergency alert. In addition, the processing system may cause other devices on the same local network, such as smart speakers, smart lights, or other IoT devices, to emit alerts via sounds or visual signals so that the user receives the emergency notification through alternative means and enhancing the likelihood that the alert is noticed. The processing system may also log these actions for future analysis of alert delivery effectiveness.

In some embodiments, the processing system may be configured to use an alternative communication method (e.g., Bluetooth, peer-to-peer network, etc.) to propagate emergency alerts in response to determining that the main communication infrastructure has been compromised. For example, the processing system may switch to Bluetooth to send emergency alerts directly to nearby immersive client devices, bypassing the compromised network. In addition, the processing system may establish a peer-to-peer network among connected devices to allow for the distribution of alerts through a decentralized communication method. This alternative approach may allow emergency alerts to reach users even when the primary network is unavailable (thus maintaining the integrity and reliability of the alert system in critical situations, etc.).

In some embodiments, the processing system may be configured to identify and analyze network traffic to identify immersive client devices, interrupt network connections of the identified immersive client devices, and/or send prompts regarding emergency alerts to the identified immersive client devices with interrupted network connections. For example, the processing system may monitor data packet sizes, protocols, and bandwidth usage to detect devices engaged in immersive activities. Upon identification, the processing system may temporarily sever the network connection to these devices and prompt them to display an emergency alert message. This interruption may divert the user's attention from the immersive content to the critical alert. In addition, the processing system may send audible or visual prompts to reinforce the emergency notification and increase the likelihood that the user will become aware of the situation.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the other methods, and vice versa.

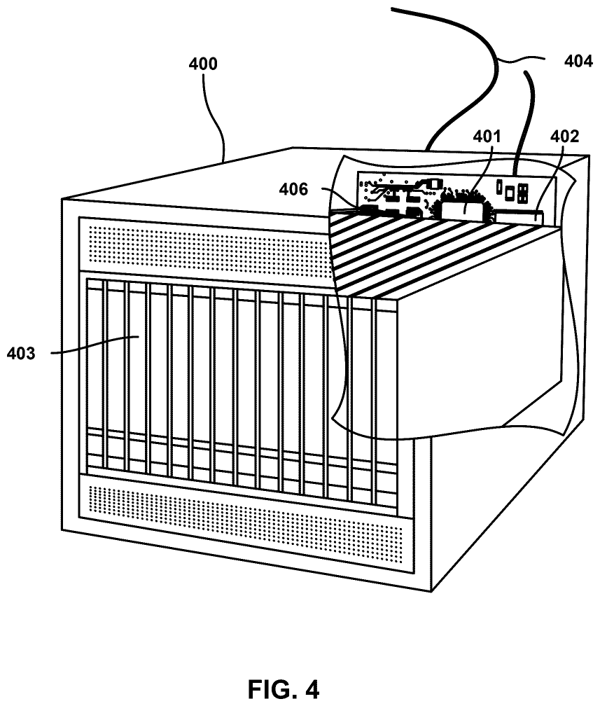

Various embodiments (including, but not limited to, embodiments discussed above with reference to FIGS. 1-3) may be implemented on any of a variety of commercially available computing devices, such as the server computing device 400 illustrated in FIG. 4. Such a server device 400 may include a processor 401 coupled to volatile memory 402 and a large capacity nonvolatile memory, such as a disk drive 403. The server device 400 may also include a floppy disc drive, USB, compact disc (CD) or DVD disc drive coupled to the processor 401. The server device 400 may also include network access ports 406 coupled to the processor 401 for establishing data connections with a network connection circuit 404 and a communication network (e.g., IP network) coupled to other communication system network elements.

The processors or processing units discussed in this application may be any programmable microprocessor, microcomputer, or multiple processor chip or chips that can be configured by software instructions (applications) to perform a variety of functions, including the functions of various embodiments described. In some computing devices, multiple processors may be provided, such as one processor within first circuitry dedicated to wireless communication functions and one processor within a second circuitry dedicated to running other applications. Software applications may be stored in the memory before they are accessed and loaded into the processor. The processors may include internal memory sufficient to store the application software instructions.

Implementation examples are described in the following paragraphs. While some of the following implementation examples are described in terms of example methods, further example implementations may include: the example methods discussed in the following paragraphs implemented by a computing device including a processor configured (e.g., with processor-executable instructions) to perform operations of the methods of the following implementation examples; the example methods discussed in the following paragraphs implemented by a computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1: A method for delivering emergency alerts to users engaged in immersive entertainment experiences, the method including subscribing, by a processing system in a service provider network, to established emergency broadcast systems to receive real-time alerts from authoritative sources, detecting, by the processing system, a new emergency alert from the subscribed emergency broadcast systems, generating, by the processing system, an alert event based on the detected emergency alert for gateway devices within an affected area, identifying, by the processing system, client devices connected to the network and classifying them as immersive or non-immersive based on at least one of hardware identification, analysis of protocol, and analysis of traffic patterns, and causing, by the processing system, the identified immersive client devices to interrupt ongoing immersive activities and display the emergency alert within an immersive environment of the identified immersive client devices by sending the generated alert event from the processing system to the identified immersive client devices.

Example 2: The method of example 1, in which the source is a reliable authoritative source that provides accurate real-time alerts.

Example 3: The method of any of the examples 1 and 2, in which generating the alert event based on the detected emergency alert for gateway devices within the affected area includes localizing the alert event based on the geographic area specified in the detected emergency alert, and tailoring the alert message to the specific type and severity of the emergency.

Example 4: The method of any of the examples 1-3, in which causing the identified immersive client devices to interrupt the ongoing immersive activities and display the emergency alert within the immersive environment of the identified immersive client devices by sending the generated alert event from the processing system to the identified immersive client devices further includes generating an audible warning sound or a flashing visual signal, or displaying alert details on an LCD display in response to determining that the immersive client devices do not support in-environment alert messages.

Example 5: The method of any of the examples 1-4, further including determining, by the processing system, whether a primary alert delivery method has failed, and disconnecting, by the processing system, the immersive client devices from the network and causing other Internet of Things (IoT) devices on the same local network to emit alerts via sounds or visual signals in response to determining that the primary alert delivery method failed.

Example 6: The method of any of the examples 1-5, further including using an alternative communication method to propagate emergency alerts in response to determining that the main communication infrastructure is compromised, the alternative communication method including at least one of a Bluetooth communication method or peer-to-peer network communication method.

Example 7: The method of any of the examples 1-6, further including identifying and analyzing network traffic to identify immersive client devices, interrupting network connections of the identified immersive client devices, and sending prompts regarding emergency alerts to the identified immersive client devices with interrupted network connections.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution, and a component may be localized on one processor or core and/or distributed between two or more processors or cores. In addition, these components may execute from various non-transitory computer-readable media with various instructions and/or data structures stored thereon. Components may communicate by way of local and/or remote processes, function or procedure calls, electronic signals, data packets, memory read/writes, and other known network, computer, processor, and/or process related communication methodologies.

A number of different types of memories and memory technologies are available or contemplated in the future, any or all of which may be included and used in systems and computing devices that implement the various embodiments. Such memory technologies/types may include non-volatile random-access memories (NVRAM) such as magnetoresistive random access memory (M-RAM), resistive random access memory (ReRAM or RRAM), phase-change random-access memory (PC-RAM, PRAM or PCM), ferroelectric Random Access Memory (F-RAM), spin-transfer torque magnetoresistive random-access memory (STT-MRAM), and three-dimensional cross point (3D-XPOINT) memory. Such memory technologies/types may also include non-volatile or read-only memory (ROM) technologies, such as programmable read-only memory (PROM), field programmable read-only memory (FPROM), one-time programmable non-volatile memory (OTP NVM). Such memory technologies/types may further include volatile random-access memory (RAM) technologies, such as dynamic random-access memory (DRAM), double data rate (DDR) synchronous dynamic random-access memory (DDR SDRAM), static random-access memory (SRAM), and pseudostatic random-access memory (PSRAM). Systems and computing devices that implement the various embodiments may also include or use electronic (solid-state) non-volatile computer storage mediums, such as FLASH memory. Each of the above-mentioned memory technologies includes, for example, elements suitable for storing instructions, programs, control signals, and/or data for use in a computing device, system on chip (SoC), or other electronic component. Any references to terminology and/or technical details related to an individual type of memory, interface, standard, or memory technology are for illustrative purposes only and not intended to limit the scope of the claims to a particular memory system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general-purpose processor, a digital signal processor (DSP), an application-specific integrated circuit (TCUASIC), a field programmable gate array (FPGA) or other programmable logic devices, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include random access memory (RAM), read-only memory (ROM), electrically erasable programmable read-only memory (EEPROM), FLASH memory, solid-state drives (SSD), non-volatile memory express (NVMe) drives, three-dimensional (3D) NAND flash, or any other medium that may be used to store target program code in the form of instructions or data structures and that may be accessed by a computer. Modern technologies, such as cloud-based storage solutions, including infrastructure-as-a-service (IaaS) platforms, may offer scalable and distributed options for storing and accessing program code. In addition, the operations of a method or algorithm may reside as one or any combination or set of codes and/or instructions on a non-transitory processor-readable medium and/or computer-readable medium, which may be incorporated into a computer program product. Emerging technologies, including quantum computing storage media and blockchain-based storage solutions, may further enhance data integrity and security. Artificial intelligence (AI) and machine learning (ML)-optimized hardware accelerators, such as graphical processing units (GPUs) and tensor processing units (TPUs), may be used to execute complex algorithms.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method for delivering emergency alerts to users engaged in immersive entertainment experiences, the method comprising:
subscribing, by a processing system in a service provider network, to established emergency broadcast systems to receive real-time alerts from sources;
detecting, by the processing system, a new emergency alert from the subscribed emergency broadcast systems;
generating, by the processing system, an alert event based on the detected emergency alert for gateway devices within an affected area;
identifying, by the processing system, client devices connected to the service provider network and classifying them as immersive or non-immersive based on at least one of hardware identification, analysis of protocol, and analysis of traffic patterns; and
causing, by the processing system, the identified immersive client devices to interrupt ongoing immersive activities and display the emergency alert within an immersive environment of the identified immersive client devices by sending the generated alert event from the processing system to the identified immersive client devices.

2. The method of claim 1, wherein the source is a reliable authoritative source that provides accurate real-time alerts.

3. The method of claim 1, wherein generating the alert event based on the detected emergency alert for gateway devices within the affected area comprises:
localizing the alert event based on a geographic area specified in the detected emergency alert; and
tailoring the alert to a specific type and severity of the emergency.

4. The method of claim 1, wherein causing the identified immersive client devices to interrupt the ongoing immersive activities and display the emergency alert within the immersive environment of the identified immersive client devices by sending the generated alert event from the processing system to the identified immersive client devices further comprises:
generating an audible warning sound or a flashing visual signal; or
displaying alert details on an LCD display in response to determining that the immersive client devices do not support in-environment alert messages.

5. The method of claim 1, further comprising:
determining, by the processing system, whether a primary alert delivery method has failed; and
disconnecting, by the processing system, the immersive client devices from the service provider network and causing other Internet of Things (IoT) devices on the same local network to emit alerts via sounds or visual signals in response to determining that the primary alert delivery method failed.

6. The method of claim 1, further comprising using an alternative communication method to propagate emergency alerts in response to determining that a main communication infrastructure is compromised, the alternative communication method including at least one of a Bluetooth communication method or peer-to-peer network communication method.

7. The method of claim 1, further comprising:
identifying and analyzing network traffic to identify immersive client devices;
interrupting network connections of the identified immersive client devices; and
sending prompts regarding emergency alerts to the identified immersive client devices with interrupted network connections.

8. A computing device, comprising:
a processing system configured to:
subscribe to established emergency broadcast systems to receive real-time alerts from sources;
detect a new emergency alert from the subscribed emergency broadcast systems;
generate an alert event based on the detected emergency alert for gateway devices within an affected area;
identify client devices connected to a service provider network and classifying them as immersive or non-immersive based on at least one of hardware identification, analysis of protocol, and analysis of traffic patterns; and
cause the identified immersive client devices to interrupt ongoing immersive activities and display the emergency alert within an immersive environment of the identified immersive client devices by sending the generated alert event from the processing system to the identified immersive client devices.

9. The computing device of claim 8, wherein the source is a reliable authoritative source that provides accurate real-time alerts.

10. The computing device of claim 8, wherein the processing system is configured to generate the alert event based on the detected emergency alert for gateway devices within the affected area by:
localizing the alert event based on a geographic area specified in the detected emergency alert; and
tailoring the alert to a specific type and severity of the emergency.

11. The computing device of claim 8, wherein the processing system is configured to cause the identified immersive client devices to interrupt the ongoing immersive activities and display the emergency alert within the immersive environment of the identified immersive client devices by sending the generated alert event to the identified immersive client devices by:
generating an audible warning sound or a flashing visual signal; or
displaying alert details on an LCD display in response to determining that the immersive client devices do not support in-environment alert messages.

12. The computing device of claim 8, wherein the processing system is further configured to:
determine whether a primary alert delivery method has failed; and
disconnect the immersive client devices from the service provider network and cause other Internet of Things (IoT) devices on the same local network to emit alerts via sounds or visual signals in response to determining that the primary alert delivery method failed.

13. The computing device of claim 8, wherein the processing system is further configured to use an alternative communication method to propagate emergency alerts in response to determining that the main communication infrastructure is compromised, the alternative communication method including at least one of a Bluetooth communication method or peer-to-peer network communication method.

14. The computing device of claim 8, wherein the processing system is further configured to:
identify and analyze network traffic to identify immersive client devices;
interrupt network connections of the identified immersive client devices; and
send prompts regarding emergency alerts to the identified immersive client devices with interrupted network connections.

15. A non-transitory computer-readable storage medium having stored thereon processor-executable software instructions configured to cause a processing system to perform operations for delivering emergency alerts to users engaged in immersive entertainment experiences, the operations comprising:
subscribing to established emergency broadcast systems to receive real-time alerts from sources;
detecting a new emergency alert from the subscribed emergency broadcast systems;
generating an alert event based on the detected emergency alert for gateway devices within an affected area;
identifying client devices connected to a service provider network and classifying them as immersive or non-immersive based on at least one of hardware identification, analysis of protocol, and analysis of traffic patterns; and
causing the identified immersive client devices to interrupt ongoing immersive activities and display the emergency alert within an immersive environment of the identified immersive client devices by sending the generated alert event from the processor to the identified immersive client devices.

16. The non-transitory computer-readable storage medium of claim 15, wherein the source is a reliable authoritative source that provides accurate real-time alerts.

17. The non-transitory computer-readable storage medium of claim 15, wherein the stored processor-executable software instructions are configured to cause a processing system to perform operations such that generating the alert event based on the detected emergency alert for gateway devices within the affected area comprises:
localizing the alert event based on a geographic area specified in the detected emergency alert; and
tailoring the alert to a specific type and severity of the emergency.

18. The non-transitory computer-readable storage medium of claim 15, wherein the stored processor-executable software instructions are configured to cause a processing system to perform operations such that causing the identified immersive client devices to interrupt the ongoing immersive activities and display the emergency alert within the immersive environment of the identified immersive client devices by sending the generated alert event from the processor to the identified immersive client devices further comprises:
generating an audible warning sound or a flashing visual signal; or
displaying alert details on an LCD display in response to determining that the immersive client devices do not support in-environment alert messages.

19. The non-transitory computer-readable storage medium of claim 15, wherein the stored processor-executable software instructions are configured to cause a processing system to perform operations further comprising:
determining whether a primary alert delivery method has failed; and
disconnecting the immersive client devices from the network and causing other Internet of Things (IoT) devices on the same local network to emit alerts via sounds or visual signals in response to determining that the primary alert delivery method failed.

20. The non-transitory computer-readable storage medium of claim 15, wherein the stored processor-executable software instructions are configured to cause a processing system to perform operations further comprising using an alternative communication method to propagate the emergency alerts in response to determining that the main communication infrastructure is compromised, the alternative communication method including at least one of a Bluetooth communication method or peer-to-peer network communication method.

21. The non-transitory computer-readable storage medium of claim 15, wherein the stored processor-executable software instructions are configured to cause a processing system to perform operations further comprising:
identifying and analyzing network traffic to identify immersive client devices;
interrupting network connections of the identified immersive client devices; and
sending prompts regarding the emergency alerts to the identified immersive client devices with interrupted network connections.
